(19) United States
(12) Patent Application Publication
(10) Pub. No.: US 2016/0212142 A1
(43) Pub. Date: Jul. 21, 2016

(54) PURPOSE-SPECIFIC PACKAGES

(71) Applicant: DocEx, Inc., Minneapolis, MN (US)

(72) Inventor: Anwar Parvez, Minneapolis, MN (US)

(21) Appl. No.: 15/003,185

(22) Filed: Jan. 21, 2016

Related U.S. Application Data
(60) Provisional application No. 62/106,136, filed on Jan. 21, 2015.

(51) Int. Cl. H04L 29/06; G06F 17/30

(52) U.S. Cl. CPC H04L 63/104; G06F 17/30082; H04L 63/0428

(57) ABSTRACT

Embodiments are provided for grouping documents into purpose-specific packages according to package settings, such as provided in a set of purpose-specific templates. In some embodiments, the purpose-specific packages and templates can be business specific. One or more data files are selected to be included in a purpose-specific package, which are uploaded and transferred to a processing queue. The processing queue generates the purpose-specific package by applying the package settings to the contents (e.g., the selected one or more data files) of the purpose-specific package.

### RELATED APPLICATION

This application claims priority to U.S. Pat. App. No. 62/106,136, filed Jan. 21, 2015, the disclosure of which is hereby incorporated by reference herein in its entirety.

### BACKGROUND

Enterprises use various storage technologies to house content. This content often needs to be selectively shared, in a traceable and auditable way, with external parties. The nature of the storage and the content varies greatly depending on the nature of the enterprise's business, and specific purposes within individual business units. The rules, security, and policies for sharing content, vary based on the external party and rules of engagement specific to that party.

### BRIEF DESCRIPTION OF THE DRAWINGS

Some embodiments are illustrated by way of example and not limitation in the figures of the accompanying drawings in which:

FIG. 1 depicts a schematic of a content management scheme, according to one or more embodiments.

FIG. 2 is a schematic diagram of an example system for generating and distributing purpose-specific packages.

FIGS. 3a and 3b are example diagrams of package security templates.

FIG. 4 is a flowchart illustrating an example method for generating a purpose-specific package.

FIG. 5 is an example step-by-step method of processing purpose-specific-packages for later distribution and tracking.

FIG. 6 is a diagrammatic representation of a machine in the example form of a computer system within which a set of instructions for causing the machine to perform any one or more of the methodologies discussed herein may be executed.

### DETAILED DESCRIPTION

The following detailed description refers to the accompanying drawings that depict various details of examples selected to show how particular embodiments may be implemented. The discussion herein addresses various examples of the inventive subject matter at least partially in reference to these drawings and describes the depicted embodiments in sufficient detail to enable those skilled in the art to practice the invention. Many other embodiments may be utilized for practicing the inventive subject matter than the illustrative examples discussed herein, and many structural and operational changes in addition to the alternatives specifically discussed herein may be made without departing from the scope of the inventive subject matter.

Embodiments are provided for grouping documents (i.e., electronic content) into purpose-specific packages according to package settings, such as provided in a set of purpose-specific templates. In some embodiments, the purpose-specific packages and templates can be business specific. One or more data files are selected to be included in a purpose-specific package, which are uploaded and transferred to one or more processing queues. The processing queues generate the purpose-specific package by applying the package settings to the contents (e.g., the selected one or more data files) of the purpose-specific package. According to embodiments of the invention, enterprises can use one solution for multiple types of sharing with various rules of engagements.

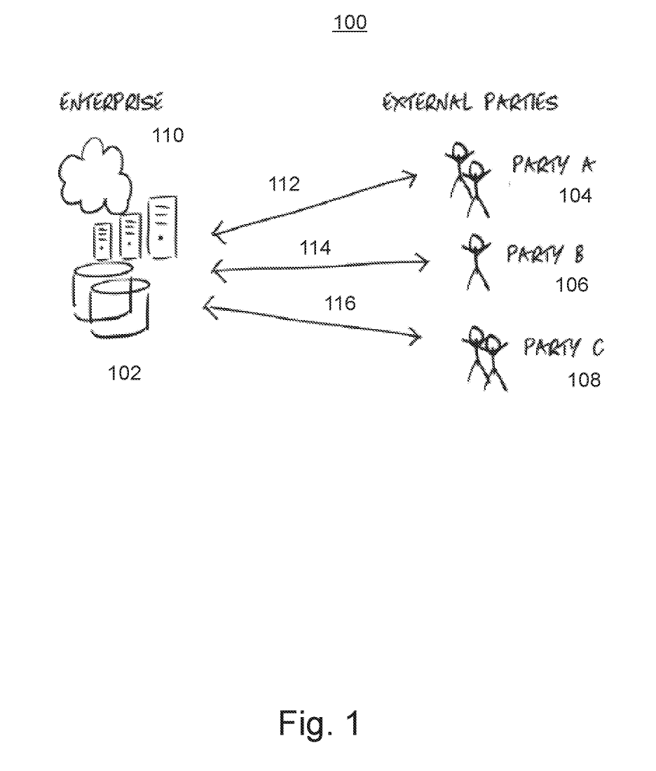

Referring now to the drawings in more detail, FIG. 1 is a schematic of a content management and sharing scheme 100. In the content management scheme 100, content from storage 102 (e.g., existing hardware, software, or cloud-based storages) is shared with external parties 104, 106, and 108 (e.g., party A, party B, and party C, respectively). However, the internal and external regulatory policies of an enterprise 110 regarding the storing and sharing of content can vary depending on the nature of the content and relationship between the enterprise 110 and the external parties 104, 106, and 108. The enterprise 110 can have a policy set 112, 114, and 116 associated with each of the external parties 104, 106, and 108, respectively.

However, the management of multiple policy sets can be prohibitively troublesome and expensive, oftentimes requiring separate applications, administrator actions, custom updates, or disparate monitoring and control. A multi-channel, storage-agnostic distribution method could support the internal and external (e.g., regulatory) policies of how an enterprise engages with external parties, allowing enterprises to keep their current storage systems and simplifying the secure delivery of documents via electronic document packages (e.g., purpose-specific packages). Various embodiments as disclosed herein relate to the distribution of enterprise class content/documents within generated purpose-specific packages.

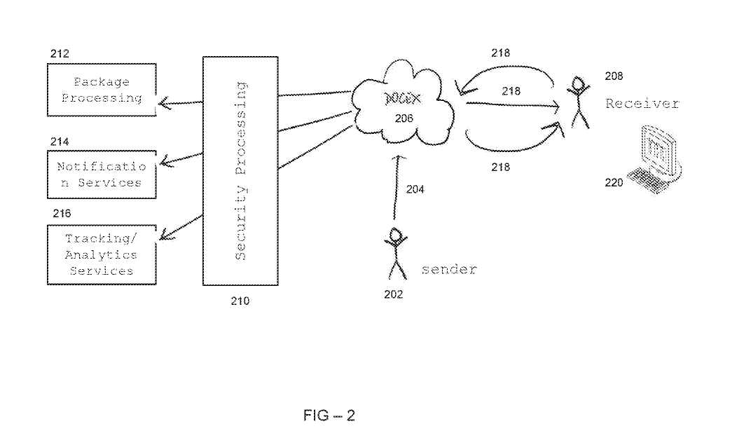

FIG. 2 is a schematic diagram of an example system for generating and distributing purpose-specific packages. Sender 202 begins generating a purpose-specific package by selecting data files 204 to be uploaded a server 206 (e.g., DocEx). In this example, the sender 202 is an enterprise user who desires to distribute purpose-specific packages (e.g., sets of documents) to a receiver 208. In other embodiments, the sender 202 can be a system that automatically selects data files according to enterprise specifications. If the selected data files have no security turned on, the files are uploaded in their native formats. However, if any security templates are selected to be applied, the data files 204 are converted to a standardized format (e.g., encrypted scrambled data, image file or PDF document) before uploading to the server 206.

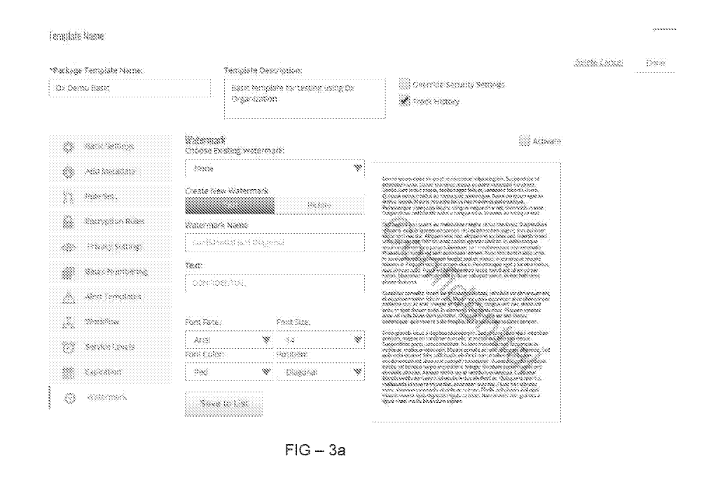

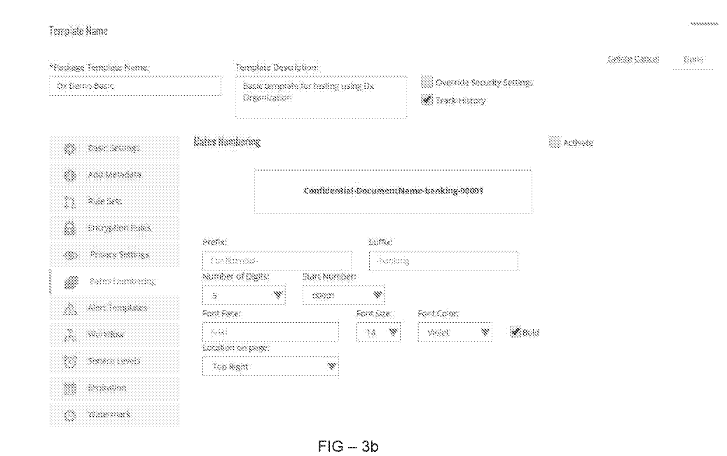

Uploaded data files are processed at a security queue 210 to apply security settings to contents that are to be included in the purpose-specific package (e.g., the selected and uploaded data files). For example, security settings can be obtained from a package security template (PST) that includes various encryption types and configurations that are applicable to the purpose-specific package. Referring now to FIGS. 3a and 3b, with continued reference to FIG. 2, illustrated is an example diagram of a package security template. Some example security settings include an ability to make content read-only (e.g., a view only setting), an ability to prohibit printing (e.g., a no print setting), an ability to prohibit sharing or downloading (e.g., a do not forward setting), a watermark, an e-signature, or an expiration setting.

Further, the package security template can include service-level agreement (SLA) management to dictate what happens to content (e.g., including both notifications and actions) at various levels of SLA violations. The package security template can also include metadata-driven rules for controlling distribution of content via purpose-specific packages. The metadata can include content metadata, user metadata, and/or group metadata. Thus, the purpose-specific can be content aware, in the sense that events of questionable content distribution may be identified and action taken. For example, actions can be taken to limit or rectify the questionable content distribution (e.g., an alert to administrators or automatic recall of distributed content). Additional security settings include, for example but is not limited to, routing rules, custom workflows, exception management, rules for detection malicious use, package distribution rules, privacy settings, industry compliance rules, custom or external security templates, service level policies, storage agnosticism setting, bates numbering, and encryption rules. The security settings as designated in a package security template are enforced across all content. However, the sender 202 can selectively apply a security configuration for each file manually if the PST allows for certain security features to be overridden. Administrators may restrict which security configuration sender 202 may apply. The settings as dictated by the PST are applied to the uploaded files 204 and used to generate a purpose-specific package using a package processing queue 212.

It is further noted that users may use different package security templates according to different types of content to be distributed. For example, an executive in an enterprise may utilize one set of security standards in a first PST for communicating with, for example, the board of directors, a different set of security standards in a second PST for communicating with government regulators, and yet another different set of security standards in a third PST for communicating with suppliers. Another example is different lawyers in the same law firm may apply different PST based on the nature of the case and who their counter parties are. Yet another example in a life sciences company, a Study Manager may use a different PST according to if the communication is shared internally or externally with hospitals.

Administrators within an enterprise can assign specific package security templates to departments, groups, and/or individual users to be applied to all distributions originating from the enterprise. Users generally only have access to the package security templates that are assigned to them from the administrators, based on the user's role within an enterprise. Alternatively, specific package security templates can be enforced based on the content or other attributes of the data file contents in a package.

The security settings, such as provided in a PST, can be purpose-specific in that custom package security templates can be created by administrators according to business purpose needs. Administrators within an enterprise can assign specific package security templates to departments, groups, and/or individual users to be applied to all distributions originating from the enterprise. For example, in relation to M&A transactions, administrators can set rules to generate alerts should a purpose-specific package improperly contain pricing data. In a different example, administrators in financial institutions can set rules to generate alerts to content being distributed that contains account information or other customer identity data (e.g., social security numbers). Contents requiring one or more levels or approvals may be processed through a workflow. In yet another example, utility companies can apply appropriate Bates Numbering to all documents in a purpose-specific package pertaining to a Rate Case. It is noted that administrators are able to monitor certain data and alerts, even in the absence of any violations of content, metadata, or distribution policies. The alerts can be provided by a notification service 214 that monitors packages for compliance with the security settings designated using tracking and analytics services 216.

After a purpose-specific package is generated, links 218 to documents/contents of the purpose-specific package are sent out using, for example, an email service from the server 206 to the receiver 208. The receiver 208 directly logs into a portal provided by server 206 or opens a configured email containing links 218 to documents/contents of associated with the purpose-specific package that are stored on server 206. For purpose-specific packages requiring less security, the contents/documents included within the package may be provided as attachments to the configured email instead of as links to a secure server. The subject, content, and links in the configured email can be personalized according to enterprise specifications. After the receiver 208 clicks the links 218, the links 218 are fetched from the server 206, which then invokes a viewer for the receiver 208 to view the document on their device 220.

The viewer may be an open source PDF/image viewer, or in the alternative, surrounded by own code to perform special handling depending on the package settings and/or the security settings. The viewer provides a consistent user interface for receiving and reviewing content distributed via a purpose-specific package, regardless of the type of package security template used to generate the purpose-specific package and the enterprise from which it was distributed.

The device 220, as shown in FIG. 2 in the form of a computer, communicates with the server 206 via a wired or wireless network communications link, and provides a graphical user interface (GUI) or other form of interface that enables a user to provide commands and to receive and optionally interact with contents of the purpose-specific package. The device can take alternative forms, including a desktop computer, a laptop computer, a mobile device, an embedded processor, a cloud computer, a central processing center accessible via the internet, and any combination of the foregoing. In many examples, the surface processor will include one or more processors in combination with additional hardware as needed (volatile and/or non-volatile memory; communication ports; I/O device(s) and ports; etc.) to provide the purpose-specific package receipt and interactions as described herein.

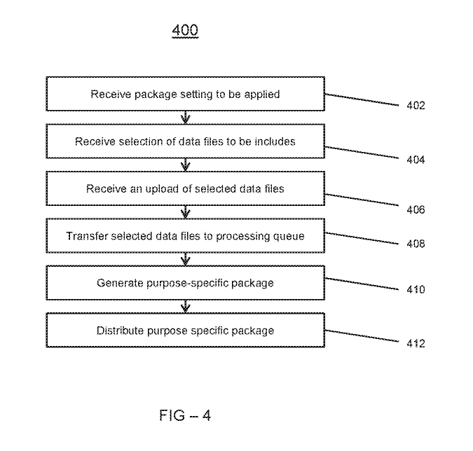

Referring now to FIG. 4, illustrated is a flow chart of a method 400 for generating a purpose-specific package. The method 400 beings at operation 402 by receiving at least one package setting to be applied to a purpose-specific package. For example, the at least one package setting can be provided via a package security template (PST) that includes various encryption types and configurations that are applicable to the purpose-specific package. In one embodiment, a template can be selected from a list of default package security templates. In another embodiment, the at least one package setting can be an assigned default package setting or an organization designated package setting based on a purpose or a role that a user holds within an enterprise.

In operation 404, a user input is received that selects one or more data files to be included in the purpose-specific package. The user input can be received from an enterprise user who desires to distribute purpose-specific packages (e.g., sets of documents) to a receiver. In some embodiments, the selection of the one or more data files can be received from a system that automatically selects data files according to enterprise specifications. In operation 406, the selected one or more data files are uploaded to a server, which are then transferred to a processing queue in operation 408.

In operation 410, the processing queue generates the purpose-specific package and applies the package setting to contents of the purpose-specific package. The package setting applied to the contents can include service-level agreement (SLA) management to dictate what happens to content (e.g., including both notifications and actions) at various levels of SLA violations. The package security template can also include metadata-driven rules for controlling distribution of content via purpose-specific packages. The metadata can include content metadata, user metadata, and/or group metadata. Thus, the purpose-specific packages can be content aware, in the sense that events of questionable content distribution may be identified and action taken. For example, actions can be taken to limit or rectify the questionable content distribution (e.g., an alert to administrators or automatic recall of distributed content). Additional security settings include, for example but is not limited to, routing rules, custom workflows, exception management, package distribution rules, privacy settings, industry compliance rules, security templates, service level policies, storage agnosticism setting, bates numbering, and encryption rules. The security settings as designated in a package security template is enforced across all content.

In operation 412 a link to the newly created purpose-specific package is distributed to sender selected or system selected (e.g. pre-defined users, groups, and roles) recipients.

Though arranged serially in the examples of FIG. 4, other examples may reorder the operations. For example based on the Enterprise requirement and hosted platform, data file selection 404 may happen before application of security setting 402. Other embodiments may also omit one or more operations, and/or execute two or more operations in parallel using multiple processors or a single processor organized as two or more virtual machines or sub-processors. Moreover, still other examples can implement the operations as one or more specific interconnected hardware or integrated circuit modules with related control and data signals communicated between and through the modules. Thus, any process flow is applicable to software, firmware, hardware, and hybrid implementations.

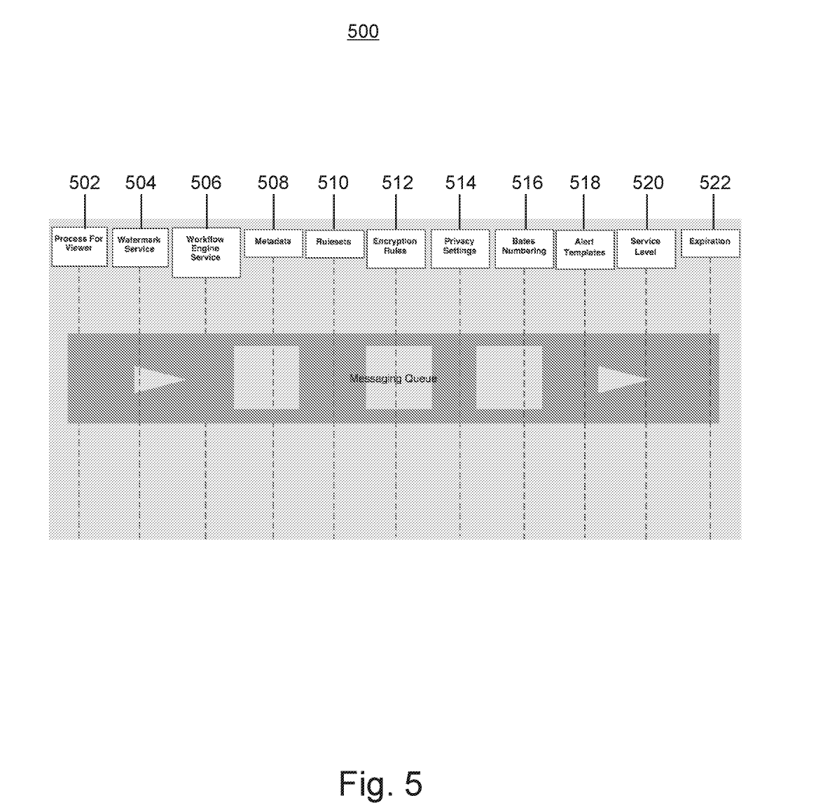

FIG. 5 illustrates a processing queue 500 used to create the purpose-specific packages as described elsewhere herein. The processing queue 500 can include a sample list of asynchronous services. The system creates and manages coupled or de-coupled services that provide various package processing functionality described elsewhere herein. Based on the PST selected for a specific package, the system determines the sequence of services that package must be processed through before being distributed through (e.g., step 412 of FIG. 4).

For example, the system processes the recipient's viewing capabilities through Process for Viewer 502. Among other viewer capabilities, this processing may determine if the package is view only or the user is allowed to print the package from the viewer or if the user may forward the package to a different user from the viewer. Should the PST include specific document marker services such as water marking 504 or bates numbering 516, the system will mark the content within the package according to the PST settings.

Enterprise use case may include very specific privacy settings 514 and encryption rules 512. For example, some packages may require two-factor authentication before viewing is allowed, other packages may need to be processed using Enterprise specific encryption keys. A PST may be customized to ask the recipient to answer privacy/security questions to open the package. Enterprises may mandate using higher levels of encryptions for higher-sensitivity contents (e.g. Department of Defense). These services may also include execution of rule sets 510, metadata driven events 508, and workflow capabilities 506 for processing the package or for escalating any violation of PST. For example, the PST may include a ruleset to identify a higher authority should the package be accessed from a malicious or unintended location. Yet another example may be in pharmaceutical companies, packages containing metadata of certain compound must always be approved by a manager before distribution.

Alert service 518, Service Level Agreement (SLA) monitoring 520, and Expiration 522 are related to the recipient's access to the package and additional notifications. For example, if a package is not opened in a PST defined time frame, system may send an alert 518 to the sender or to the recipient. Even then if the package is not opened, the system may expire the recipients' access to the package.

Though arranged serially in the examples of FIG. 5, PST settings will determine the order of the services and their executions. PST settings may also omit one or more services, and/or execute two or more operations in parallel using multiple processors or a single processor organized as two or more virtual machines or sub-processors. Moreover, still other examples can implement the operations as one or more specific interconnected hardware or integrated circuit modules with related control and data signals communicated between and through the modules. Thus, any process flow is applicable to software, firmware, hardware, and hybrid implementations.

### Example Machine Architecture and Machine-Readable Medium

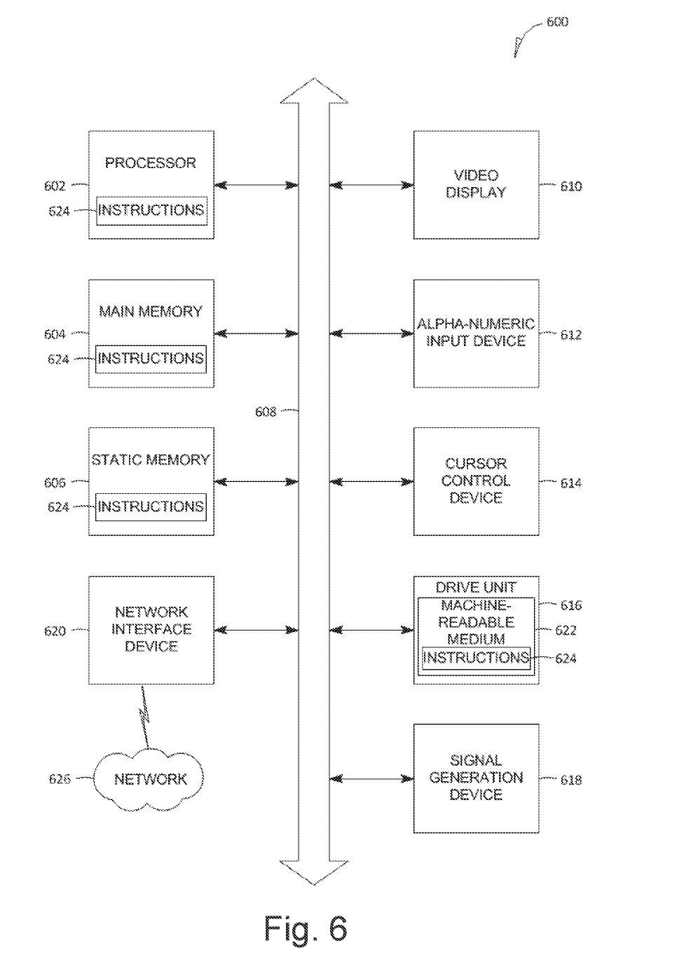

The methods and systems described herein may be implemented by software for generating purpose-specific packages, which may be comprised within an application or an operating system executing on a computer system. FIG. 6 is a block diagram of a machine in the example form of a computer system 600 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation device 614 (e.g., a mouse), a disk drive unit 616, a signal generation device 618 (e.g., a speaker) and a network interface device 620.

### Machine-Readable Medium

The disk drive unit 616 includes a machine-readable medium 622 on which is stored one or more sets of instructions and data structures (e.g., software) 624 embodying or used by any one or more of the methodologies or functions described herein. The instructions 624 may also reside, completely or at least partially, within the main memory 604, static memory 606, and/or within the processor 602 during execution thereof by the computer system 600, the main memory 604 and the processor 602 also constituting machine-readable media.

While the machine-readable medium 622 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing or encoding data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks. All such machine readable storage media are hardware devices suitable for storing data and/or instructions for a suitable period of time to enable use by the machine, and are therefore non-transitory.

### Transmission Medium

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

In this description, references to “one embodiment” or “an embodiment,” or to “one example” or “an example” mean that the feature being referred to is, or may be, included in at least one embodiment or example of the invention. Separate references to “an embodiment” or “one embodiment” or to “one example” or “an example” in this description are not intended to necessarily refer to the same embodiment or example; however, neither are such embodiments mutually exclusive, unless so stated or as will be readily apparent to those of ordinary skill in the art having the benefit of this disclosure. Thus, the present disclosure includes a variety of combinations and/or integrations of the embodiments and examples described herein, as well as further embodiments and examples as defined within the scope of all claims based on this disclosure, as well as all legal equivalents of such claims.

Although embodiments have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for generating a purpose-specific package, the method comprising:
receiving at least one package setting to be applied to the purpose-specific package;
receiving a first user input selecting one or more data files to be included in the purpose-specific package;
receiving an upload of the one or more data files; and
transferring the one or more data files to a processing queue;
generating, using the processing queue, the purpose-specific package, wherein the at least one package setting are applied to contents of the purpose-specific package.

2. The method of claim 1, wherein receiving at least one package setting comprises a second user input selecting a package template from a list of default template options.

3. The method of claim 1, wherein receiving at least one package setting comprises receiving a default package setting or an organization designated package setting.

4. The method of claim 1, further comprising:
applying a security setting to contents of the purpose-specific package, wherein the security setting includes at least one of a view only setting, a no print setting, a do not forward setting, a watermark, an e-signature, and an expiration setting.

5. The method of claim 1, wherein the at least one package setting includes at least one of a package distribution rule, an encryption rule, a configurable privacy setting, a bates numbering, a service level policy, a storage agnosticism setting, and a routing or processing rule based on a workflow.

6. The method of claim 1, further comprising:
encrypting, through a configurable encryption via key and method selection, the purpose-specific package.

7. The method of claim 1, further comprising:
receiving a second user input providing at least one document setting, overriding or in addition to the settings applied from the package template, to be applied to a single data file of the one or more data files.

8. A non-transitory computer-readable medium storing instructions for execution by the one or more processors, the instructions when executed by the one or more processors cause the one or more processors to perform operations including:
receiving at least one package setting to be applied to the purpose-specific package;
receiving a first user input selecting one or more data files to be included in the purpose-specific package;
receiving an upload of the one or more data files; and
transferring the one or more data files to a processing queue;
generating, using the processing queue, the purpose-specific package, wherein the at least one package setting are applied to contents of the purpose-specific package.

9. The non-transitory computer-readable medium of claim 8, wherein receiving at least one package setting comprises a second user input selecting a package template from a list of default template options.

10. The non-transitory computer-readable medium of claim 8, wherein receiving at least one package setting comprises receiving a default package setting or an organization designated package setting.

11. The non-transitory computer-readable medium of claim 8, further comprising instructions that cause applying a security setting to contents of the purpose-specific package, wherein the security setting includes at least one of a view only setting, a no print setting, a do not setting, a watermark, an e-signature, and an expiration setting.

12. The non-transitory computer-readable medium of claim 8, wherein the at least one package setting includes at least one of a package distribution rule, an encryption rule, a configurable privacy setting, a bates numbering, a service level, a storage agnosticism, and a routing rule based on workflow.

13. The non-transitory computer-readable medium of claim 8, further comprising instructions that cause encrypting, through a configurable encryption via key and method selection, the purpose-specific package.

14. The non-transitory computer-readable medium of claim 8, further comprising instructions that cause receiving a second user input providing at least one document setting to be applied to a single data file of the one or more data files.

15. A system comprising:
at least one processor; and
a computer-readable medium storing one or more sequences of instructions which, when executed by the at least one processor, causes:
receiving at least one package setting to be applied to the purpose-specific package;
receiving a first user input selecting one or more data files to be included in the purpose-specific package;
receiving an upload of the one or more data files; and
transferring the one or more data files to a processing queue;
generating, using the processing queue, the purpose-specific package, wherein the at least one package setting are applied to contents of the purpose-specific package.

16. The system of claim 15, further comprising instructions that cause applying a security setting to contents of the purpose-specific package, wherein the security setting includes at least one of a view only setting, a no print setting, a do not setting, a watermark, an e-signature, and an expiration setting.

17. The system of claim 15, wherein receiving at least one package setting comprises a second user input selecting a package template from a list of default template options.

18. The system of claim 15, wherein the at least one package setting includes at least one of a package distribution rule, an encryption rule, a configurable privacy setting, a bates numbering, a service level, a storage agnosticism, and a routing rule based on workflow.

19. The system of claim 15, further comprising instructions that cause receiving a second user input providing at least one document setting to be applied to a single data file of the one or more data files.

20. The system of claim 15, further comprising instructions that cause receiving at least one of a default package setting, an organization designated package setting, or a second user input selecting a package template from a list of default template options.
